(19) United States
(12) Patent Application Publication
(10) Pub. No.: US 2015/0257006 A1
(43) Pub. Date: Sep. 10, 2015

(54) SECURITY MECHANISM FOR SHORT RANGE RADIO FREQUENCY COMMUNICATION

(71) Applicant: Alcatel Lucent, Paris (FR)

(72) Inventors: Afra Mashhadi, Dublin (IE); Vijay Venkateswaran, Dublin (IE); Aidan Boran, Longwood (IE)

(73) Assignee: Alcatel Lucent, Paris (FR)

(21) Appl. No.: 14/197,307

(22) Filed: Mar. 5, 2014

(51) Int. Cl. H04W 12/08; H04W 84/18

(52) U.S. Cl. CPC H04W 12/08; H04W 84/18

(57) ABSTRACT

A capability for securing short range radio frequency (RF) communication is presented. The capability for securing short range RF communication may be provided by configuring an RF tag and an RF reader such that only that RF reader (or any other appropriately configured RE reader) is able to detect the presence of the RF tag. The RF tag may be configured to receive a signal from an RF reader and to use backscatter spread modulation to spectrally spread the received signal at the RF tag to form a spread signal having an average energy per unit frequency that is below a noise threshold, thereby rendering the RF tag undetectable by the RF reader if the RF reader is not configured to correctly de-spread the spread signal of the RF tag (or by any other RF reader not configured to correctly de-spread the spread signal of the RF tag).

### TECHNICAL FIELD

The disclosure relates generally to short range radio frequency (RF) communications and, more specifically but not exclusively, to security of short range RF communications.

### BACKGROUND

Short range radio frequency (RF) communication may be used in various contexts and for various purposes. For example, short range RF communications based on RF Identification (RFID) standards may be used for asset tracking (e.g., tracking products through design processes, tracking items through warehouses, tracking animals and humans, or the like), infrastructure access (e.g., keyless access to buildings and other locations), data exchanges, and so forth. Similarly, for example, short range RF communications based on Near Field Communications (NFCs) standards may be used for contactless transactions, data exchanges, simplified setup of more complex communications, and so forth.

Short range RF communication is typically performed between a radio transponder and a radio transceiver. For example, in the case of RFID applications, the radio transponder may be an RFID tag (e.g., attached to a physical object, such as a product, work of art, animal, human, or the like) and the radio transceiver may be an RFID reader. For example, in the case of NFC applications, the radio transponder and radio transceiver may be an RF tag and an RF reader, where either or both of the RF tag or the RF reader may be a smartphone, a tablet computer, or the like.

In general, the current design and use of such systems is primarily based on an assumption that the radio transceiver has or may negotiate permission to access the radio transponder. In cases in which the radio transceiver has permission to access the radio transponder, the radio transceiver is able to discover, identify, and communicate with the radio transponder. Similarly, even in cases in which the radio transceiver does not have permission to access the radio transponder (without at least performing some form of authentication) the radio transceiver is still able at least to discover, and in some cases identify, the radio transponder. Thus, existing mechanisms for short range RF communication are vulnerable to unauthorized discovery, tracking, and inventorying of radio transponders such as RFID tags, devices configured to operate as radio transponders, and so forth.

### SUMMARY OF EMBODIMENTS

Various deficiencies in the prior art are addressed by embodiments for securing short range wireless communication.

In at least some embodiments, an apparatus includes an antenna and a backscatter spread modulator communicatively connected to the antenna. The antenna is configured to receive a signal having a signal energy spread over a first range of frequencies. The backscatter spread modulator is configured to spread the received signal to form a spread signal in which the signal energy of the received signal is spread over a second range of frequencies greater than the first range of frequencies, where the second range of frequencies is configured to provide an average signal energy per unit frequency for the spread signal that is less than a noise threshold.

In at least some embodiments, a method includes receiving, via an antenna, a signal having a signal energy spread over a first range of frequencies, and spreading the received signal, using a backscatter spread modulator communicatively connected to the antenna, to form a spread signal in which the signal energy of the received signal is spread over a second range of frequencies greater than the first range of frequencies, where the second range of frequencies is configured to provide an average signal energy per unit frequency for the spread signal that is less than a noise threshold.

In at least some embodiments, an apparatus includes a signal source and a de-spreader. The signal source is configured to transmit a first signal having a first signal energy spread across a first range of frequencies. The de-spreader is configured to receive a second signal having a second signal energy spread across a second range of frequencies greater than the first range of frequencies, where the second signal includes a spread version of the first signal. The de-spreader also is configured to de-spread the second signal in a manner for concentrating the second signal energy of the second signal within the first range of frequencies to recover thereby the first signal.

In at least some embodiments, a method includes transmitting a first signal having a first signal energy spread across a first range of frequencies, receiving a second signal having a second signal energy spread across a second range of frequencies greater than the first range of frequencies where the second signal includes a spread version of the first signal, and de-spreading the second signal in a manner for concentrating the second signal energy of the second signal within the first range of frequencies to recover thereby the first signal.

### BRIEF DESCRIPTION OF THE DRAWINGS

The teachings herein can be readily understood by considering the detailed description in conjunction with the accompanying drawings, in which:

FIG. 1 depicts an exemplary system for radio frequency communication between a reader and a tag;

FIG. 2 depicts an exemplary embodiment of a backscatter spread modulator of the tag of FIG. 1;

FIG. 3 depicts an embodiment of a method for secure radio frequency communication between a reader and a tag; and

FIG. 4 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

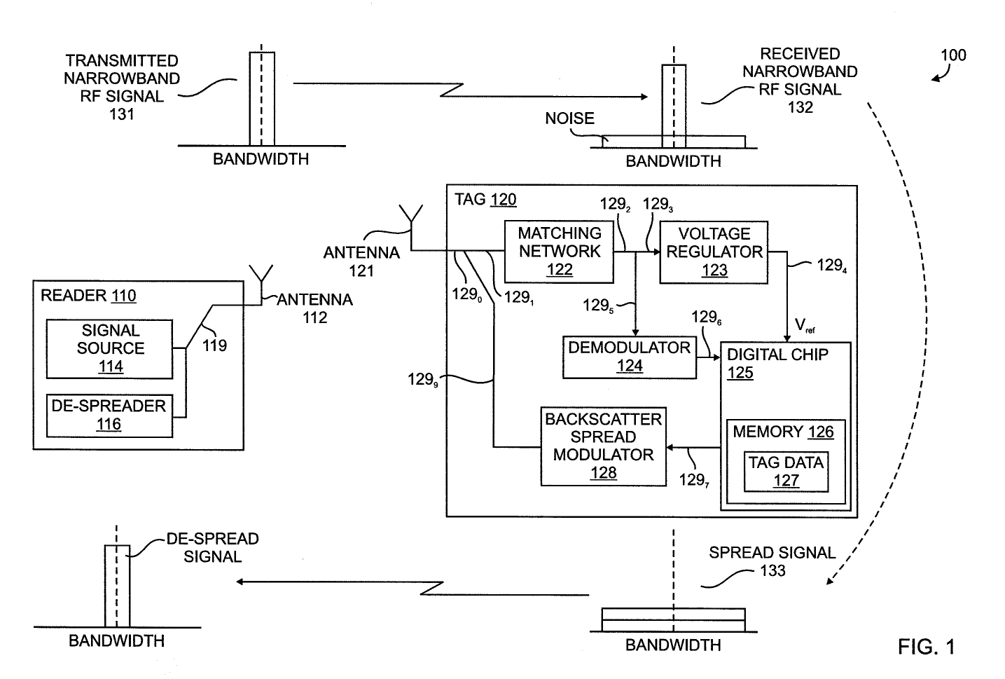

A capability for securing short range radio frequency (RF) communication is presented herein. In at least some embodiments, the capability for securing short range RF communication is provided by configuring an RF tag and an RF reader such that only that RF reader (or any other appropriately configured RF reader) is able to detect the presence of the RF tag. In at least some embodiments, an RF tag is configured to receive a signal from an RF reader and to use backscatter spread modulation to spectrally spread the received signal at the RF tag to form a spread signal having an average energy that is below a noise threshold, thereby rendering the RF tag undetectable by the RF reader if the RF reader is not configured to correctly de-spread the spread signal of the RF tag (or by any other RF reader that is not configured to correctly de-spread the spread signal of the RF tag). In this manner, an RF tag may be configured such that the RF tag may only be detected by an authorized RF reader(s) appropriately configured to detect the RF tag, thereby removing existing assumptions that any RF reader is trustworthy to detect any RF tag and, thus, providing improved security for the RF tag. These and various other embodiments of the capability for securing short range RF communication may be better understood by way of reference to FIG. 1.

FIG. 1 depicts an exemplary system for radio frequency communication between a reader and a tag.

The exemplary system 100 includes a radio frequency reader (reader) 110 and a radio frequency tag (tag) 120. The reader 110 and tag 120 may be based on Radio Frequency Identification (RFID) standards (e.g., an RFID reader and an RFID tag), NFC standards, or the like. The exemplary system 100, for purposes of clarity in describing embodiments of the capability for securing short range RF communication, is assumed to be a passive tag system in which tag 120 is a passive tag and the reader 110 is configured to radiate RF energy for powering tag 120 and causing tag 120 to transmit tag data (e.g., an identity of the tag 120, a state of the tag 120, or any other data which may be stored on tag 120) from tag 120 to reader 110. As discussed in additional detail below, however, it will be appreciated that embodiments of the capability for securing short range RF communication may be applied to various types of tags in addition to passive tags (e.g., semi-passive tags, active tags, or the like).

The reader 110 and the tag 120 are configured such that the reader 110 is able to detect the presence of tag 120 and to communicate with tag 120 (e.g., receive tag data stored by tag 120 or the like). In other words, the reader 110 and the tag 120 are configured such that the reader 110 is able (and, thus, authorized) to detect the presence of tag 120 and to communicate with tag 120 (as opposed to other readers, omitted for purposes of clarity, which, if not configured to detect the presence of tag 120, are not authorized to detect the presence of the tag 120).

The reader 110 may be configured as depicted in FIG. 1. Namely, the reader 110 may include an antenna 112, a signal source 114, and a de-spreader 116. The various elements of the reader 110 are connected via a set of signal paths 119, which are described in additional detail below. It will be appreciated that the reader 110 may include fewer or more elements, as well as various other elements. It will be appreciated that the reader may be configured to operate using magnetic induction, backscatter propagation, or the like, as well as various combinations thereof. It will be appreciated that reader 110 may be an RFID reader or any other suitable type of reader.

The tag 120 also may be configured as depicted in FIG. 1. Namely, the tag 120 may include an antenna 121, a matching network 122, a voltage regulator 123, a demodulator 124, a digital chip 125 including a memory 126 storing tag data 127, and a backscatter spread modulator 128. The various elements of tag 120 are connected via a set of signal paths 129, which are described in additional detail below. It will be appreciated that the tag 120 may include fewer or more elements, as well as various other elements. It will be appreciated that tag 120 may be an RFID tag or any other suitable type of tag.

As depicted in FIG. 1, reader 110 transmits a narrowband RF signal 131. The transmitted narrowband RF signal 131 may be generated by signal source 114 and transmitted via antenna 112. The transmitted narrowband RF signal 131 has a signal energy that is contained within a bandwidth range of the transmitted narrowband RF signal 131. The transmitted narrowband RF signal 131 is centered at a relatively narrow range of bandwidths.

As depicted in FIG. 1, tag 120 receives a narrowband RF signal 132. The tag 120 receives received narrowband RF signal 132 via antenna 121. The received narrowband RF signal 132 that is received by tag 120 is a modified version of transmitted narrowband RF signal 131 that has been corrupted by noise. The received narrowband RF signal 132 is centered at the same relatively narrow range of bandwidths at which the transmitted narrowband RF signal 131 was generated and transmitted by reader 110 (i.e., again, the signal energy of received narrowband RF signal 132 is contained within the bandwidth range of received narrowband RF signal 132). The received narrowband RF signal 132 propagates from antenna 121 to a signal path 129₀, which splits into two signal paths (illustratively, signal paths 129₁ and 129₉) such that at least a portion of the signal energy of received narrowband RF signal 132 propagates via signal path 129₁ and at least a portion of the signal energy of received narrowband RF signal 132 propagates via signal path 129₉.

The tag 120, responsive to received narrowband RF signal 132, produces a spread signal 133. The spread signal 133 includes a combination of a spectrally spread version of the received narrowband RF signal 132 and a spectrally spread version of a data signal produced by the digital chip 125 (conveying the tag data 127 of digital chip 125) responsive to powering of digital chip 125 by energy of the received narrowband RF signal 132. In this manner, the spectral spreading of the signal components output by tag 120 responsive to received narrowband RF signal 132 is adapted to render the tag 120 undetectable by any reader that is not configured to correctly de-spread the spectrally spread signal output by the tag 120. The spectral spreading of the signal components output by tag 120 responsive to received narrowband RF signal 132 (namely, spectral spreading of received narrowband RF signal 132 and the data signal conveying the tag data 127 of digital chip 125) is performed by backscatter spread modulator 128, as discussed in additional detail below.

The received narrowband RF signal 132 is propagated via signal path 129₁ for purposes of providing functions such as powering digital chip 125, triggering digital chip 125 to propagate tag data 127 toward reader 110, and the like. The received narrowband RF signal 132 is received by matching network 122 via signal path 129₁. The matching network 122 is configured to maximize power transfer and to minimize the standing wave ratio. The output of matching network 122 is coupled to an input to voltage regulator 123 (via signal paths 129₂ and 129₃) and to an input to demodulator 124 (via signal paths 129₂ and 129₄). The voltage regulator 123 converts energy of received narrowband RF signal 132 into voltage (illustratively, V_{ref}) that is used to power digital chip 125 for enabling transmission of the tag data 127 of the tag 120 to the reader 110. The tag data 127 of the digital chip 125 is output from the digital chip 125 as a data signal conveying the tag data 127. The data signal conveying the tag data 127 of the digital chip 125 is provided to backscatter spread modulator 128 via signal path 129₇. The backscatter spread modulator 128 is configured to spectrally spread the data signal conveying the tag data 127 of the digital chip 125. The backscatter spread modulator 128 is configured to spectrally spread the data signal conveying the tag data 127 across a range of frequencies sufficient to reduce the signal energy per unit frequency of the data signal to a value that is below the noise floor, thereby ensuring that spread signal 133 that is output via antenna 121 of tag 120 is only detectable by reader 110 (or any other reader configured to correctly de-spread spread signal 133). It is noted that the noise floor also may be referred to herein as a noise threshold, as it may represent the threshold at which a signal other than noise may be detectable (e.g., a signal having an associated signal energy per unit frequency or bandwidth that is above the noise floor may be detected as a signal other than noise). The spreading of the data signal conveying the tag data 127 of the digital chip 125 to form part of spread signal 133 also may be considered to be a spectral distribution of the data signal conveying the tag data 127 of the digital chip 125 from a relatively narrow range of frequencies to a wider range of frequencies sufficient to reduce the signal energy per unit frequency (or bandwidth, given that the range of frequencies has a bandwidth associated therewith) to a value that is below the noise floor. In other words, backscatter spread modulator 128 is configured to modulate or transform the data signal conveying the tag data 127 of the digital chip 125 (having a first set of spectral properties, in which the signal is distributed over a first range of frequencies) into a spectrally spread version of the data signal conveying the tag data 127 of the digital chip 125 (having a second set of spectral properties, in which the signal is distributed over a second range of frequencies that is larger than the first range of frequencies and is adapted to reduce the signal energy per unit frequency to a value that is below the noise floor) such that the SNR of the spectrally spread version of the data signal conveying the tag data 127 of the digital chip 125 is small enough to render spread signal 133 undetectable by any reader that is not configured to de-spread the spectral signal 133 output by tag 120. The data signal conveying tag data 127 of digital chip 125 modulates the impedance at the antenna 121 of the tag 120, thereby contributing to an impedance mismatch at the antenna 121 of the tag 120 that causes tag 120 to reflect and radiate a modified version of the received narrowband RF signal 132 received at the antenna 121 of the tag 120 (modified based on spectral spreading of the received narrowband RF signal 132 by backscatter spread modulator 128, as discussed in additional detail below).

The received narrowband RF signal 132 is propagated via signal path 129₉ for purposes of enabling backscatter spread modulator 128 to spectrally spread received narrowband RF signal 132. The backscatter spread modulator 128 receives the received narrowband RF signal 132 from antenna 121 via signal path 129₉. The backscatter spread modulator 128 is configured to spectrally spread the received narrowband RF signal 132 across a range of frequencies sufficient to reduce the signal energy per unit frequency to a value that is below the noise floor, thereby ensuring that spread signal 133 that is output via antenna 121 of tag 120 is only detectable by reader 110 (or any other reader configured to correctly de-spread spread signal 133). The spreading of the received narrowband RF signal 132 to form a spectrally spread version of the received narrowband RF signal 132 also may be considered to be a spectral distribution of the received narrowband RF signal 132 from a relatively narrow range of frequencies to a wider range of frequencies sufficient to reduce the signal energy per unit frequency to a value that is below the noise floor. In other words, backscatter spread modulator 128 is configured to modulate or transform received narrowband RF signal 132 (having a first set of spectral properties, in which the signal is distributed over a first range of frequencies) into a spectrally spread version of received narrowband RF signal 132 (having a second set of spectral properties, in which the signal is distributed over a second range of frequencies that is larger than the first range of frequencies and is adapted to reduce the signal energy per unit frequency to a value that is below the noise floor) such that the SNR of the spectrally spread version of received narrowband RF signal 132 is small enough to render spread signal 133 undetectable by any reader that is not configured to de-spread the spectral signal 133 reflected by tag 120. The received narrowband RF signal 132 modulates the impedance at the antenna 121 of the tag 120, thereby contributing to an impedance mismatch at the antenna 121 of the tag 120 that causes tag 120 to reflect and radiate the spectrally spread version of the received narrowband RF signal 132 received at the antenna 121 of the tag 120.

The backscatter spread modulator 128 may spectrally spread received signals (illustratively, the data signal conveying the tag data 127 of the digital chip 125 and the narrowband RF signal 132) by modifying the received signals in order to contribute to an impedance mismatch at the antenna 121 of tag 120. As discussed above, the impedance mismatch produced at the antenna 121 of tag 120 is a function of both (1) the data signal conveying the tag data 127 of the digital chip 125 (which is provided to the backscatter spread modulator 128 from digital chip 125 via signal path 129₇) and (2) the spread signal 133 produced by backscatter spread modulator 128 (which includes a spectrally spread version of the data signal conveying the tag data 127 of the digital chip 125 and a spectrally spread version of the received narrowband RF signal 132 by backscatter spread modulator 128). It is noted that the transfer function between the antenna 121 (output) and the digital chip 125 (input) is the overall impedance and operates equivalent to a spread signal transfer function. As a result, the spread signal 133 that is output from the antenna 121 of the tag 120, again, includes a spectrally spread version of the data signal conveying the tag data 127 of the digital chip 125 and a spectrally spread version of the received narrowband RF signal 132 by backscatter spread modulator 128. It is noted that even, though there are no active components, the spectral spreading provided by the backscatter spread modulator 128 reduces the signal energy per unit frequency such that the tag 120 is invisible to any reader that is not configured to properly de-spread the spread signal 133 that is output from the antenna 121 of the tag 120.

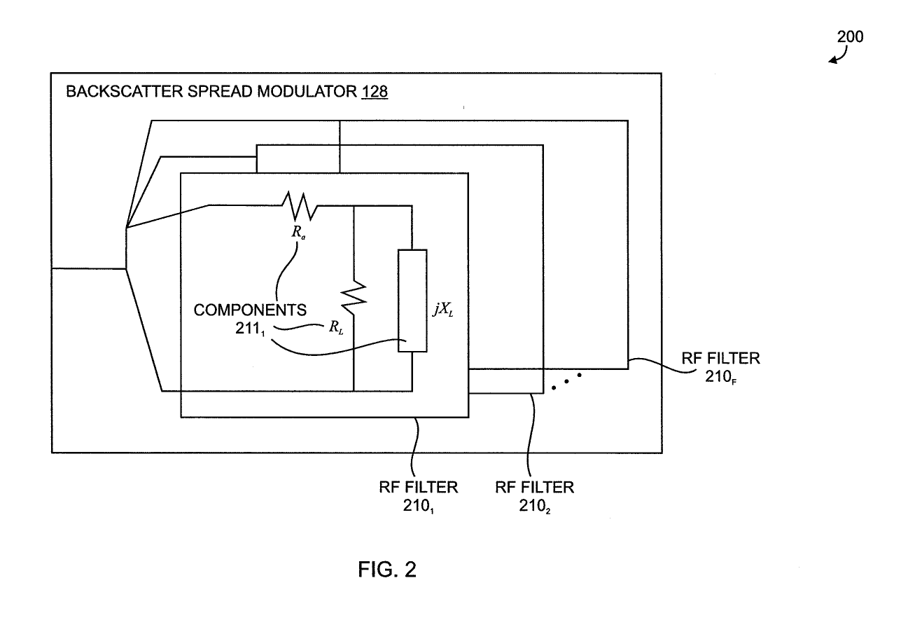

The backscatter spread modulator 128 may be implemented using any RF circuit configured to provide the functions of backscatter spread modulator 128 as discussed herein. For example, backscatter spread modulator 128 may be implemented as an RF filter-bank, a set of polyphase filters, frequency-selective RF circuitry, or the like, as well as various combinations thereof. An exemplary embodiment of a backscatter spread modulator implemented as an RF filter bank is depicted in FIG. 2.

FIG. 2 depicts an exemplary embodiment of a backscatter spread modulator of the tag of FIG. 1. As depicted in FIG. 2, backscatter spread modulator 128 of tag 120 may be implemented as a bank of RF filters 210₁-210_{F} (collectively, RF filters 210 or RF filter-bank 210). The RF filters 210₁-201_{F} are circuits including respective sets of components 211₁-211_{F} (collectively, component sets 211) which may be configured to provide spectral spreading as discussed herein. The sets of components 211₁-211_{F} of RF filters 210 may include one or more frequency selective components (e.g., capacitors, inductors, or the like, as well as various combinations thereof). In the exemplary RF filters 210 of FIG. 2, for example, the frequency selective components are inductors. More specifically, the exemplary RF filters 210 of FIG. 2 each include a first resister Rₐ, a second resister R_{L}, and an inductor XL (having a reactive inductance of jX_{L}), where the second resister R_{L} and the inductor X_{L} are in parallel with each other and the first resister Rₐ is in series with the parallel combination of the second resister R_{L} and the indictor X_{L}. It will be appreciated that various other types, numbers, or arrangements of components (including frequency selective components) may be used to provide RF filters of backscatter spread modulator 128. It is noted that, frequency selective components, when used to provide a filter, are typically designed to provide resonance at one particular frequency; however, here, frequency selective components of RF filters 210 may be designed such that signals received by backscatter spread modulator 128 (e.g., the data signal conveying the tag data 127 of the digital chip 125 and the narrowband RF signal 132) are spread toward multiple frequencies as a result of losses radiated when the RF filters 210 are not resonant, thereby producing the spectral signal spreading described as being provided by backscatter spread modulator 128. The impedance of each of the components 211 in the bank of RF filters 210 may be modified as a static phase shift of each other. It is noted that the bank of RF filters 210 may be based on the fact that an equivalent circuit, as seen from antenna 121 to digital chip 125, may be modeled as a filter or a transmission line capable of either reflecting or absorbing signals based on its impedance. The bank of RF filters 210 may be deemed to be fixed after the impedance of each of the components 211 of the bank of RF filters 210 is designed to have a relative phase shift with the other components 211 of the bank of RF filters 210. The bank of RF filters 210 modulates the data signal conveying tag data 127 of digital chip 125 to form the spectrally spread version of the data signal conveying tag data 127 of digital chip 125. The bank of RF filters 210 also modulates the received narrowband RF signal 132 to form the spectrally spread version of received narrowband RF signal 132. Thus, as discussed above, the transfer function between the antenna 121 (output) and the digital chip 125 (input) is the overall impedance and operates equivalent to a spread signal transfer function, such that the spread signal 133 that is output from the antenna 121 of the tag 120 includes a combination of the spectrally spread version of the data signal conveying tag data 127 of digital chip 125 and the spectrally spread version of received narrowband RF signal 132.

Returning again to FIG. 1, it will be appreciated that, while the total signal energy output by tag 120 using backscatter spread modulator 128 is the same as or substantially similar to the total signal energy that would be output by the tag 120 in the absence of backscatter spread modulator 128, the spreading factor of the backscatter spread modulator 128 significantly reduces the signal energy per unit frequency such that the spread signal 133 that is output by the tag 120 is below the noise floor, thereby preventing unauthorized readers from even detecting tag 120, much less obtaining data (e.g., tag data 127) from tag 120. In this manner, the backscatter spread modulator 128 renders reflected signal 133 (and, thus, tag 120) undetectable by any reader that is not configured to correctly de-spread the spread signal 133 reflected by tag 120.

In contrast to tag 120, existing tags are configured such that (1) the impedance mismatch is only a function of the information sequence from the digital chip of the existing tag and (2) the received narrowband RF signal received by the existing tag is reflected without any spreading, such that most of the reflected RF signal received by a reader from the typical tag would, similar to transmitted narrowband RF signal 131 and received narrowband RF signal 132, be centered at a relatively narrow range of bandwidths (i.e., such that the reflected RF signal would be above the noise floor and, thus, would be detectable by any reader within range of the existing tag, regardless of whether or not the reader was authorized to detect the existing tag).

As depicted in FIG. 1, reader 110 receives the spread signal 133 that is output by tag 120. The reader 110 receives spread signal 133 via antenna 111. The spread signal 133 is spread across a range of frequencies such that the signal energy per unit frequency is below the noise floor and, thus, in the absence of correct de-spreading of the spread signal 133 at reader 110, would not be detected by reader 110.

The reader 110 is configured, based on knowledge of signal spreading performed by backscatter spread modulator 128 at the tag 120, such that the reader 110 is capable of de-spreading the spread signal 133 received from the tag 120. More specifically, de-spreader 116 of reader 110 is configured to de-spread the spread signal 133 received from the tag 120 to form thereby de-spread signal 134 depicted in FIG. 1. The de-spreader 116 is configured to perform de-spreading of spread signal 133 to form de-spread signal 134 based on knowledge of the spectral spreading performed by the backscatter spread modulator 128 of the tag 120 (e.g., based on knowledge of the spread sequence used by the tag 120). For example, de-spreader 116 may be a rake-receiver, an equalizer, or the like. Accordingly, de-spread signal 134 may be a narrowband RF signal similar to that of transmitted narrowband RF signal 131 and received narrowband RF signal 132 (e.g., the signal energy of the spread signal 133 received at reader 110 is returned to the relatively narrow range of frequencies of transmitted narrowband RF signal 131 and received narrowband RF signal 132).

The reader 110 also may be configured to estimate the information sequence of the de-spread signal 134 (e.g., to recover the tag data 127 provided by tag 120 as part of spread signal 133). The reader 110 is not expected to be limited by power requirements or circuitry complexity and, thus, the reader 110 may include a non-coherent demodulator configured to determine the information sequence of the de-spread signal 134 (e.g., to recover the tag data 127 provided by tag 120 as part of spread signal 133). The reader may determine the information sequence of the de-spread signal 134 in any other suitable manner.

In this manner, reader 110 and tag 120 are configured to ensure that only reader 110 (or a reader(s) similarly configured to de-spread spread signal 133) is able to detect the presence of tag 120 and, thus, only reader 110 (or, again, a reader(s) similarly configured to de-spread spread signal 133) is able to read data from tag 120. Namely, a reader that is broadcasting in the frequency range of the tag 120 will not be able to detect the tag 120 unless the reader is configured to correctly de-spread the spread signal 133 received from the tag 120 based on the spectral spreading performed by the tag 120 (in other words, if the reader is not configured based on knowledge of the spectral spreading by the backscatter spread modulator 128 of the tag 120, then the SNR levels observed at the reader will be below the noise floor, or threshold, necessary to even detect the presence of the tag 120). Accordingly, no malicious reader(s) will be able to detect the presence of tag 120, thereby rendering tag 120 invisible to any malicious readers.

It will be appreciated that, although primarily depicted and described with respect to embodiments for providing security for a specific type of passive tag (namely, embodiments in which tag 120 is a passive tag using a voltage mismatch for operation), various embodiments for providing security may be adapted for providing security for passive tags configured to operate in other ways (e.g., passive tags based on antenna coils). For example, a passive tag may include more than one set of impedance coils and the design of the impedance coils may be used to create the impedance mismatch in a way that spreads the received narrowband RF signal to form the spread signal that is radiated from the antenna of the passive tag.

It will be appreciated that, although primarily depicted and described with respect to embodiments for providing security for a specific type of tag (namely, embodiments in which tag 120 is a passive tag), various embodiments for providing security may be adapted for providing security for other types of tags (e.g., semi-passive tags, active tags, or the like).

In at least some embodiments, security may be provided for an active tag. In general, an active tag includes a power source (e.g., a small battery) which enables the active tag to synthesize a modulated sequence. In at least some embodiments, the modulated sequence of an active tag can be programmed and used to create the impedance mismatch that is reflected by the active tag through the backscatter spread modulator. The modulated sequence may be hard-coded, programmed as a spread sequence based on M-sequence generator polynomials with ultra-low complexity, or provided in any other suitable manner. It will be appreciated that the antenna does not radiate any signal and, thus, there is no need to include any amplifier (which would lead to an undesirable increase in power consumption).

It will be appreciated that, although primarily depicted and described with respect to embodiments for providing security independent of the operational mode of the tag (e.g., near-field operation vs. far-field operation), embodiments for providing security may be utilized with any suitable tag operational modes. For example, embodiments for providing security may be utilized with near-field tags (e.g., those based on magnetic induction principles), far-field tags (e.g., those based on electromagnetic (EM) wave capture), or the like, as well as various combinations thereof.

It will be appreciated that, although primarily depicted and described with respect to embodiments in which the reader 110 includes a single antenna 111 (such that transmitted narrowband RF signal 131 is transmitted via antenna 111 and spread signal 133 is received via antenna 111) and the tag 120 includes a single antenna 112 (such that received narrowband RF signal 132 is received via antenna 112 and spread signal 133 is transmitted via antenna 112), in at least some embodiments the reader 110 may include multiple antennas and the tag 120 may include multiple antennas. In at least some such embodiments, reader 110 may transmit transmitted narrowband RF signal 131 via a reader transmit antenna, tag 120 may receive received narrowband RF signal 132 via a tag receive antenna, tag 120 may output spread signal 133 via a tag transmit antenna, and reader 110 may receive spread signal 133 via a reader receive antenna.

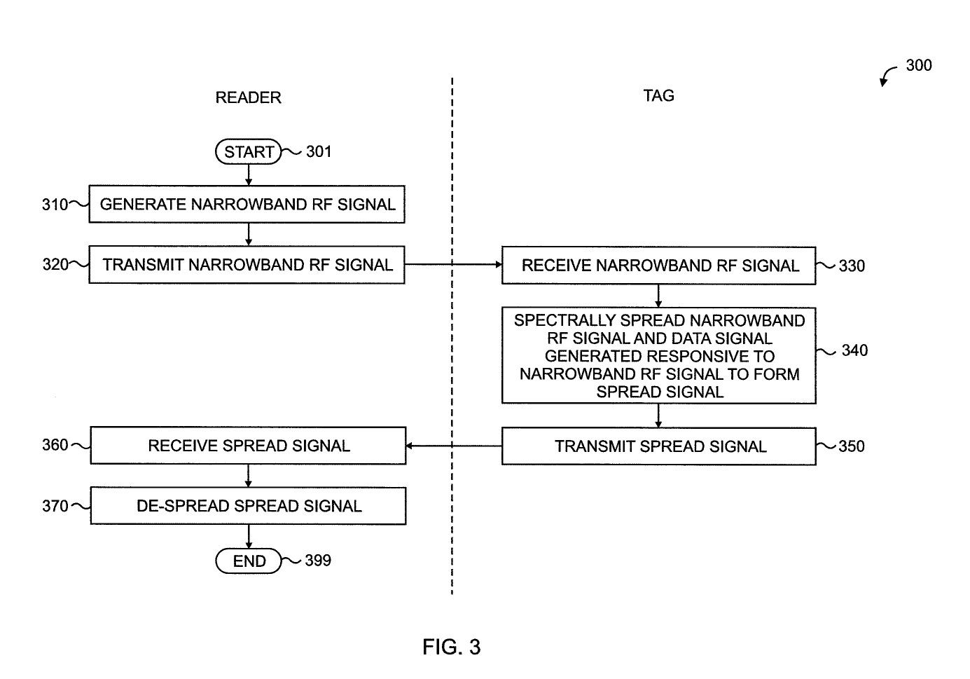

FIG. 3 depicts an embodiment of a method for secure radio frequency communication between a reader and a tag. As depicted in FIG. 3, a portion of the steps of method 300 are performed by the reader and a portion of the steps of method 300 are performed by the tag. At step 301, method 300 beings. At step 310, the reader generates a narrowband RF signal. At step 320, the reader transmits the narrowband RF signal. At step 330, the tag receives the narrowband RF signal. At step 340, the tag spectrally spreads the narrowband RF signal and a data signal generated responsive to the narrowband RF signal to form a spread signal. At step 350, the tag transmits the spread signal. At step 360, the reader receives the spread signal. At step 370, the reader de-spreads the spread signal. At step 399, method 300 ends.

It is noted that embodiments of the capability for securing short range RF communication provide significant security and privacy in that (1) it is expected to be quite difficult to detect and interrogate a tag without the correct reader for the tag (e.g., given the extremely large number of potential combinations of RF signal modulation which could be used) and (2) given that security is provided for relatively short range radio frequency communications, it is expected to be impossible or impractical for any long term eavesdropping which might be used to try to detect a tag. It is noted that embodiments of the security capability provide improvements over security that is based on key-based or secret-based encryption techniques (e.g., use of Digital Signature Transponders (DSTs) or other similar techniques), because, while such encryption techniques may enable encryption of signals from the tag, such encryption techniques do not make the tag invisible to unauthorized readers (rather, at a minimum, the tags can be detected and possibly tracked and, thus, information may be compromised). It is noted that embodiments of the security capability may provide significant security and privacy in a zero-cost or near-zero-cost manner. It is noted that embodiments of the security capability also may provide energy savings for certain types of tags (e.g., semi-passive tags, active tags, or the like) by preventing the tags from waking up and transmitting data when unauthorized readers attempt to detect or access the tags.

It will be appreciated that, although primarily depicted and described herein with respect to providing improved security for specific types of short range RF communications (e.g., communication between a reader and a tag), various embodiments depicted and described herein may be used to provide improved control for other types of short range RF communications. For example, various embodiments depicted and described herein may be used to provide improved security for contactless transactions between user devices (e.g., data exchanges between smartphones, data exchanges between smartphones and tablets, or the like), RF-based data exchanges between devices based on machine-to-machine (M2M) communication, or the like, as well as various combinations thereof.

It will be appreciated that, although primarily depicted and described within the context of securing short range RF communications between an RFID reader and an RFID tag, various embodiments depicted and described herein may be used to secure short range RF communications between various other types of devices. For example, various embodiments depicted and described herein may be used to secure short range RF communications between other types of radio transceivers and radio transponders. For example, various embodiments depicted and described herein may be used to secure short range RF communications between devices operating based on NFC standards, such as for contactless data transmissions between smartphones, data exchanges between communication devices, simplified setup of more complex communications, or the like, as well as various combinations thereof. Various other applications for securing wireless communications (including hiding the presence of target devices from devices that are unauthorized to detect the presence of such target devices) are contemplated.

It will be appreciated that, although primarily depicted and described with respect to securing short range RF communication, various embodiments depicted and described herein also may be used to provide robust signal detection in the presence of RF interference and noise, to provide enhanced RF range (e.g., RFID range) in the presence of RF interference and noise, or the like, as well as various combinations thereof. For example, a combination of spreading a signal via backscatter modulation and de-spreading the signal using a rake receiver may provide one or more such benefits in the presence of RF interference and noise.

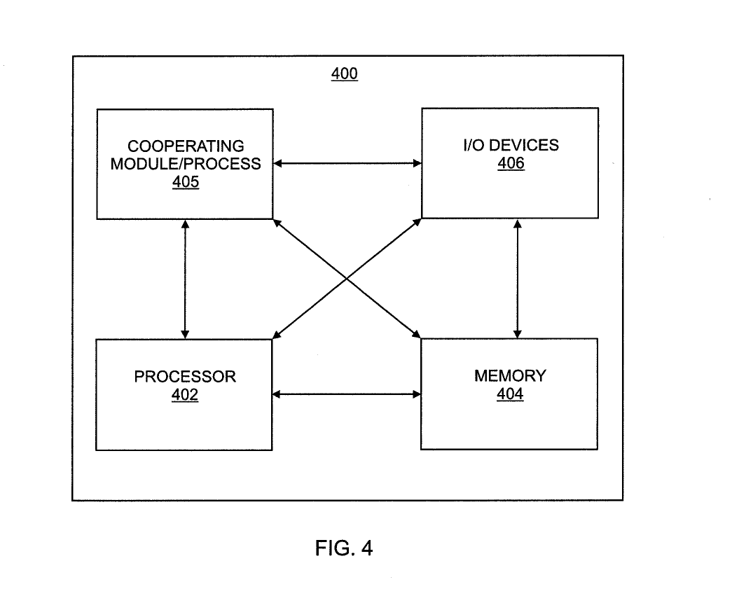

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 400 depicted in FIG. 4 provides a general architecture and functionality suitable for implementing functional elements described herein and/or portions of functional elements described herein. For example, computer 400 may represent a general architecture and functionality suitable for implementing one or more of reader 110 or a portion of reader 110, tag 120 or a portion of tag 120 (e.g., digital chip 127), or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the described methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
an antenna configured to receive a signal having a signal energy spread over a first range of frequencies; and
a backscatter spread modulator communicatively connected to the antenna, the backscatter spread modulator configured to spread the received signal to form a spread signal in which the signal energy of the received signal is spread over a second range of frequencies greater than the first range of frequencies, the second range of frequencies configured to provide an average signal energy per unit frequency for the spread signal that is less than a noise threshold.

2. The apparatus of claim 1, wherein the backscatter spread modulator is configured to reflect the spread signal toward the antenna for transmission via the antenna.

3. The apparatus of claim 1, wherein the backscatter spread modulator is configured to direct the spread signal toward a second antenna for transmission via the second antenna.

4. The apparatus of claim 1, further comprising:
a chip configured to store data associated with the apparatus.

5. The apparatus of claim 4, wherein the data associated with the apparatus comprises at least one of an identity of the apparatus or a state of the apparatus.

6. The apparatus of claim 4, further comprising:
a power source configured to power the chip.

7. The apparatus of claim 4, further comprising:
a voltage regulator configured to convert at least a portion of the signal energy of the received signal into a voltage to power the chip.

8. The apparatus of claim 4, wherein the chip is configured to:
propagate, toward the backscatter spread modulator, a data signal conveying the data stored by the chip.

9. The apparatus of claim 8, wherein the data signal comprises second signal energy, wherein the backscatter spread modulator is configured to:
spectrally spread the data signal to form a spread data signal in which the second signal energy of the data signal is spread over a range of frequencies configured to provide an average signal energy per unit frequency for the spread data signal that is less than the noise threshold.

10. The apparatus of claim 1, wherein the backscatter spread modulator is configured to spread the received signal to form the spread signal by modifying the received signal in a manner for contributing to an impedance mismatch at the antenna.

11. The apparatus of claim 1, wherein the backscatter spread modulator comprises an RF filter bank, a set of polyphase filters, or frequency-selective RF circuitry.

12. The apparatus of claim 1, wherein the backscatter spread modulator comprises an RF filter bank including a set of RF filters, wherein each of the RF filters comprises at least one frequency selective component, wherein the frequency selective components of the RF filter bank are configured to spread the received signal toward the second range of frequencies based on losses radiated when the RF filters are not resonant.

13. The apparatus of claim 1, wherein the apparatus is a passive tag, an active tag, a near field tag, a far field tag, or an RF transponder.

14. A method, comprising:
receiving, via an antenna, a signal having a signal energy spread over a first range of frequencies; and
spreading the received signal, using a backscatter spread modulator communicatively connected to the antenna, to form a spread signal in which the signal energy of the received signal is spread over a second range of frequencies greater than the first range of frequencies, the second range of frequencies configured to provide an average signal energy per unit frequency for the spread signal is less than a noise threshold.

15. An apparatus, comprising:
a signal source configured to transmit a first signal having a first signal energy spread across a first range of frequencies; and
a de-spreader configured to:
receive a second signal having a second signal energy spread across a second range of frequencies that is greater than the first range of frequencies, the second range of frequencies configured to provide an average signal energy per unit frequency for the second signal that is less than a noise threshold, the second signal comprising a spread version of the first signal; and
de-spread the second signal in a manner for concentrating the second signal energy of the second signal within the first range of frequencies to recover thereby the first signal.

16. The apparatus of claim 15, wherein the second signal further comprising a spread version of a data signal, wherein a signal energy of the spread version of the data signal is spread over the second range of frequencies, wherein the de-spreader is configured to de-spread the spread version of the data signal.

17. The apparatus of claim 15, wherein the de-spreader comprises a rake receiver or an equalizer.

18. The apparatus of claim 15, further comprising:
an antenna communicatively connected to the signal source and the de-spreader.

19. The apparatus of claim 15, wherein the apparatus is a reader or an RF transceiver.

20. A method, comprising:
transmitting a first signal having a first signal energy spread across a first range of frequencies;
receiving a second signal having a second signal energy spread across a second range of frequencies greater than the first range of frequencies, the second range of frequencies configured to provide an average signal energy per unit frequency for the second signal that is less than a noise threshold, the second signal comprising a spread version of the first signal; and
de-spreading the second signal in a manner for concentrating the second signal energy of the second signal within the first range of frequencies to recover thereby the first signal.
